(19) United States
(12) Patent Application Publication
(10) Pub. No.: US 2026/0242248 A1
(43) Pub. Date: Aug. 20, 2026

(54) PASSIVE GROUNDWATER TREATMENT BARRIER SYSTEM

(71) Applicant: Tetra Tech, Inc., Pasadena, CA (US)

(72) Inventor: Gary Keyes, Healdsburg, CA (US)

(21) Appl. No.: 19/536,617

(22) Filed: Feb. 11, 2026

Related U.S. Application Data
(60) Provisional application No. 63/757,583, filed on Feb. 12, 2025.

(51) Int. Cl. C02F 1/28; B09C 1/00; C02F 1/00; C02F 1/42; C02F 101/10; C02F 101/36; C02F 103/06

(52) U.S. Cl. CPC C02F 1/283; B09C 1/002; C02F 1/008; C02F 1/288; C02F 1/42; B09C 2101/00; C02F 1/281; C02F 1/285; C02F 2101/10; C02F 2101/36; C02F 2103/06; C02F 2201/005

(57) ABSTRACT

Various implementations include a passive groundwater treatment barrier system. The system includes an in-situ hydraulic barrier wall constructed in a path of flow of a contaminated groundwater plume. At least one water-tight treatment vessel is positioned proximate to (and preferably upgradient of) the barrier wall, the treatment vessel containing a treatment media and configured for downflow of groundwater through the media. A groundwater infiltration and collection system is located upgradient of the barrier wall to convey contaminated groundwater to the treatment vessel. The system includes a hydraulic head control apparatus and a conveyance pipe passing through the barrier wall and connecting the treatment vessel to the hydraulic head control apparatus. A outlet which, in some implementations, includes a distribution system positioned downgradient of the barrier wall to disperse treated groundwater.

### BACKGROUND

Groundwater contamination is a significant environmental concern that affects water resources worldwide. Various pollutants, including volatile organic compounds (VOCs), heavy metals, and emerging contaminants such as per- and polyfluoroalkyl substances (PFAS), can infiltrate aquifers and pose risks to human health and ecosystems. Traditional remediation approaches often involve pump-and-treat systems, which extract contaminated groundwater, treat it above ground, and then reinject or discharge the treated water. However, these methods can be energy-intensive, costly to operate and maintain, and may require long-term implementation to achieve cleanup goals.

In recent years, passive in-situ treatment technologies have gained attention as potentially more cost-effective and sustainable alternatives for groundwater remediation. Permeable reactive barriers (PRBs) are one such approach, typically involving the installation of reactive materials in the path of contaminated groundwater flow to remove or degrade pollutants as the water passes through. Funnel-and-gate systems are a variation of PRBs that use impermeable barriers to direct groundwater through a permeable treatment zone or “gate.” While these passive systems can offer advantages over pump-and-treat methods, they also face challenges related to long-term performance, hydraulic control, and the ability to replace or rejuvenate treatment media.

The remediation of PFAS compounds in groundwater presents particular challenges due to their persistence, mobility, and the stringent regulatory standards being established for these contaminants. Conventional treatment technologies like granular activated carbon (GAC) adsorption or ion exchange can be effective for PFAS removal but eventually require very expensive media replacement when implemented in traditional PRB configurations. Additionally, ensuring complete capture and treatment of contaminated groundwater plumes can be difficult with existing passive barrier designs, especially in heterogeneous subsurface environments, where localized breakthrough can occur.

Thus, a need exists for an improved passive groundwater treatment system that provides reliable hydraulic control, allows for efficient media replacement or rejuvenation, and can effectively address a range of contaminants, including recalcitrant compounds like PFAS, while minimizing long-term operation and maintenance costs.

### SUMMARY

Various implementations provide a passive groundwater treatment barrier system. The system includes an in-situ hydraulic barrier wall constructed in a path of flow of a contaminated groundwater plume. The system includes at least one water-tight treatment vessel containing a treatment media and configured for downflow of groundwater through the media. The system includes a groundwater infiltration and collection system upgradient of the barrier wall to convey contaminated groundwater to the treatment vessel with minimal hydraulic head loss. The system includes a hydraulic head control apparatus. The system includes a conveyance pipe passing through the barrier wall and connecting the treatment vessel to the hydraulic head control apparatus. The system includes a outlet downgradient of the barrier wall to release treated groundwater with minimal head loss.

In some implementations, the treatment media comprises at least one of granular activated carbon, ion exchange resin, surface-modified granular organo-clay media, or a combination thereof. In some implementations, the treatment vessel comprises multiple sampling ports positioned at different depths of the treatment media. In some implementations, the groundwater infiltration and collection system comprises at least one of French drains or horizontal wells. In some implementations, the outlet includes a distribution system comprising at least one of French drains or horizontal wells. In some implementations, the system further comprises shutoff valves configured to isolate the treatment vessel from surrounding groundwater. In some implementations, the treatment vessel is configured to allow for removal and replacement of a portion of the treatment media while leaving a remaining portion of the treatment media in place. In some implementations, the treatment vessel is configured to allow for removal and replacement of an upper portion of the treatment media using at least one of vacuum pumps or slurry pumps. In some implementations, the at least one water-tight treatment vessel is positioned upgradient of the barrier wall. In some implementations, the system further comprises multiple treatment vessels arranged in series, wherein each treatment vessel contains a different type of treatment media. In some implementations, a first treatment vessel contains granular activated carbon, and a second treatment vessel contains ion exchange resin or surface-modified granular organo-clay media. In some implementations, the hydraulic head control apparatus comprises a weir. In some implementations, the system further comprises multiple water-tight treatment vessels connected to an in-situ manifold configured for lead-lag operation, wherein the manifold allows isolation of individual treatment vessels during media changeout. In some implementations, the system further comprises an in-situ manifold connecting multiple treatment vessels, the in-situ manifold located in a watertight manhole. In some implementations, the system further comprises an in-situ manifold connecting multiple treatment vessels, the in-situ manifold including valves configured to switch flow between lead and lag treatment vessels. In some implementations, the system further comprises an in-situ manifold connecting multiple treatment vessels, the in-situ manifold including shutoff valves configured to prevent untreated groundwater from passing through the barrier wall during media changeout. In some implementations, the hydraulic head control apparatus comprises an adjustable weir configured to accommodate seasonal fluctuations in groundwater elevations. In some implementations, the adjustable weir is configured for at least one of manual adjustment or automated motorized control. In some implementations, the treatment vessel includes intermediate horizontal distribution zones within the treatment media to reduce channeling. In some implementations, the treatment vessel includes tie-down features to prevent buoyancy-induced rising during media changeout. In some implementations, the treatment vessel is approximately 6 feet in diameter. In some implementations, the treatment media comprises at least one of granular activated carbon, ion exchange resin, surface-modified granular organo-clay media, or other media configured to treat contaminants including at least one of PFAS, chlorinated volatile organic compounds, energetics, BTEX, or metals. In some implementations, the barrier wall is configured in a non-linear alignment based on at least one of groundwater contours, site topography, or surface features. In some implementations, the groundwater infiltration and collection system and the outlet are positioned based on hydrogeologic modeling. In some implementations, the system is configured for sites where depth to groundwater is less than 25 feet below ground surface and depth to a competent aquitard is less than 100 feet below ground surface. In some implementations, the groundwater infiltration and collection system comprises French drains when depth to groundwater is less than 10 feet below ground surface, or horizontal wells when depth to groundwater is greater than 10 feet below ground surface. In some implementations, the system further comprises a watertight manhole comprising corrugated crosslinked polyethylene culvert pipe mounted vertically below grade with a heat-welded bottom cap. In some implementations, the system further comprises a hoist mechanism positioned above a watertight manhole containing an in-situ manifold. In some implementations, the system further comprises multiple treatment vessels configured for series flow during normal operation, wherein groundwater flows through a lead treatment vessel and then through a lag treatment vessel before being dispersed through the distribution system. In some implementations, the system further comprises multiple sets of treatment vessels arranged in series, each set comprising a lead vessel and a lag vessel connected to a control manifold. In some implementations, a first set of treatment vessels contains granular activated carbon and a second set of treatment vessels contains ion exchange resin and/or surface-modified granular organo-clay media.

Various implementations provide a method of treating contaminated groundwater using a passive barrier system. The method includes intercepting a contaminated groundwater plume with an in-situ hydraulic barrier wall. The method includes causing the contaminated groundwater to be directed through a groundwater infiltration and collection system upgradient of the barrier wall. The method includes causing the contaminated groundwater to pass in a downflow direction through a water-tight treatment vessel containing treatment media, the treatment vessel positioned upgradient or downgradient of the barrier wall. The method includes causing treated groundwater to be conveyed through a pipe passing through the barrier wall. The method includes causing hydraulic head to be controlled with an apparatus in fluid communication with the pipe. The method includes causing the treated groundwater to be released through an outlet. In some implementations, the treated water is dispersed through a distribution system downgradient of the barrier wall. In other implementations, treated groundwater is released through an outlet to a discharge point such as a surface water body, storm drain or sewer.

In some implementations, the treatment media comprises at least one of granular activated carbon, ion exchange resin and/or surface-modified granular organo-clay media. In some implementations, the treatment media comprises a first layer of granular activated carbon and a second layer of ion exchange resin or surface-modified granular organo-clay media. In some implementations, the method further comprises monitoring contaminant levels at multiple depths of the treatment vessel using sampling ports. In some implementations, the method further comprises selectively removing and replacing an upper portion of the treatment media based on the monitored contaminant levels. In some implementations, the groundwater infiltration and collection system and the distribution system each comprise at least one of French drains or horizontal wells. In some implementations, the method further comprises causing the treatment vessel to be isolated from surrounding groundwater using shutoff valves during maintenance operations. In some implementations, the at least one water-tight treatment vessel is positioned upgradient of the barrier wall. In some implementations, causing the contaminated groundwater to pass through the treatment vessel comprises passing the groundwater through multiple treatment vessels arranged in series. In some implementations, a first treatment vessel contains granular activated carbon, and a second treatment vessel contains ion exchange resin and/or surface-modified granular organo-clay media. In some implementations, the hydraulic head control apparatus comprises a weir. In some implementations, the method further comprises isolating the treatment vessel for maintenance and redirecting flow to a lag treatment vessel, wherein the lag treatment vessel becomes a new lead treatment vessel after maintenance is complete. In some implementations, the method further comprises operating valves in an in-situ manifold to isolate a lead treatment vessel and redirect flow to a lag treatment vessel. In some implementations, the method further comprises adjusting a hydraulic control weir to accommodate seasonal fluctuations in groundwater elevations. In some implementations, adjusting the hydraulic control weir comprises at least one of manual adjustment or automated motorized control. In some implementations, the method further comprises removing spent treatment media from the treatment vessel and sending the spent treatment media off-site for at least one of reactivation or incineration. In some implementations, the treatment media is placed in lifts with intermediate distribution zones to reduce channeling of water through the treatment media. In some implementations, the method further comprises causing the contaminated groundwater to flow through a lead treatment vessel and then through a lag treatment vessel in series during normal operation. In some implementations, the method further comprises monitoring for contaminant breakthrough in a lead treatment vessel and, upon detecting breakthrough, isolating the lead treatment vessel and redirecting flow to a lag treatment vessel. In some implementations, the method further comprises, after changeout of treatment media in an isolated treatment vessel, adjusting valves in a manifold to convert the isolated treatment vessel into a lag treatment vessel.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a plan view of a passive groundwater treatment barrier system, according to one implementation.

FIG. 2 is a section view of the passive groundwater treatment barrier system of FIG. 1 along section line 2-2, according to another implementation.

FIG. 3 is a plan view of a passive groundwater treatment barrier system including multiple water-tight treatment vessels connected to an in-situ manifold configured for lead-lag operation, according to another implementation.

FIG. 4 is an isometric view of an in-situ manifold for a passive groundwater treatment barrier system in a lead configuration, according to one implementation.

FIG. 5 is an isometric view of the in-situ manifold for a passive groundwater treatment barrier system of FIG. 4 in a lag configuration.

### DETAILED DESCRIPTION

The passive groundwater treatment barrier system described herein provides an improved approach for remediating contaminated groundwater plumes. This system offers a passive, low-maintenance solution for treating groundwater contamination, particularly in scenarios where conventional pump-and-treat or in-situ remediation methods may be less effective or cost-prohibitive.

The system utilizes a combination of physical barriers, treatment media, and hydraulic control features to intercept, treat, and redistribute contaminated groundwater. By leveraging natural groundwater flow and strategically placed components, the system minimizes energy requirements and operational complexity while maintaining effective contaminant removal.

In some cases, the passive groundwater treatment barrier system may be particularly well-suited for sites with specific hydrogeologic conditions. For example, the system may be most effective at sites where the depth to groundwater is less than 20 feet below ground surface (bgs) and the depth to a competent aquitard is less than 50 feet bgs. These conditions may allow for more efficient installation and operation of the system components.

The system described herein may offer advantages over traditional remediation approaches, including reduced long-term operational costs, improved reliability in achieving hydraulic control, and flexibility in treating various types of contaminants. The passive nature of the system may also result in lower energy consumption and reduced maintenance requirements compared to active treatment systems.

Various implementations include a passive groundwater treatment barrier system. The system includes an in-situ hydraulic barrier wall constructed in a path of flow of a contaminated groundwater plume. At least one water-tight treatment vessel contains a treatment media and configured for downflow of groundwater through the media. The system also includes a groundwater infiltration and collection system upgradient of the barrier wall to convey contaminated groundwater to the treatment vessel, a hydraulic head control apparatus, a conveyance pipe passing through the barrier wall and connecting the treatment vessel to the hydraulic head control apparatus, and a outlet downgradient of the barrier wall to release treated groundwater. In some implementations, the outlet includes a distribution system to disperse treated groundwater.

Various other implementations include a method of treating contaminated groundwater using a passive barrier system. The method includes intercepting a contaminated groundwater plume with an in-situ hydraulic barrier wall, causing the contaminated groundwater to be directed through a groundwater infiltration and collection system upgradient of the barrier wall, and causing the contaminated groundwater to pass in a downflow direction through a water-tight treatment vessel containing treatment media. The method further includes causing treated groundwater to be conveyed through a pipe passing through the barrier wall, causing hydraulic head to be controlled with an apparatus connected to the pipe, and causing the treated groundwater to be released through a outlet downgradient of the barrier wall. In some implementations, the outlet includes a distribution system to disperse the treated groundwater.

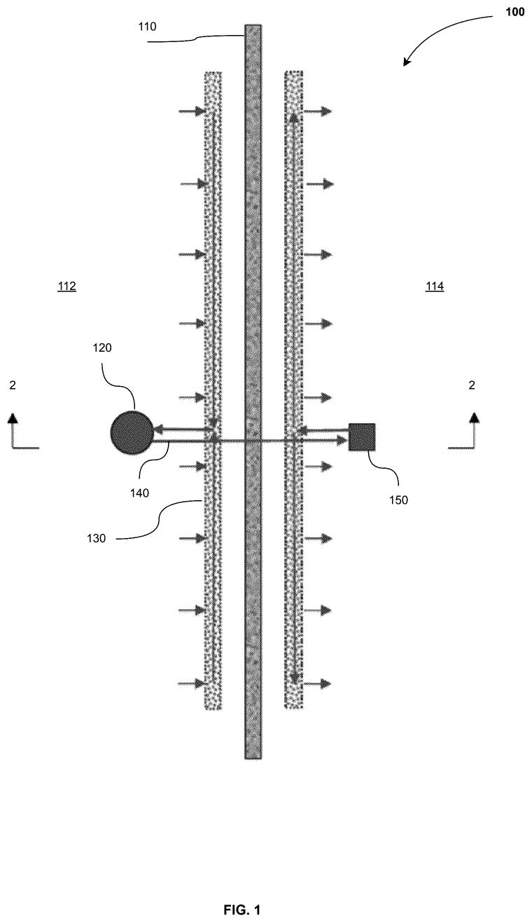

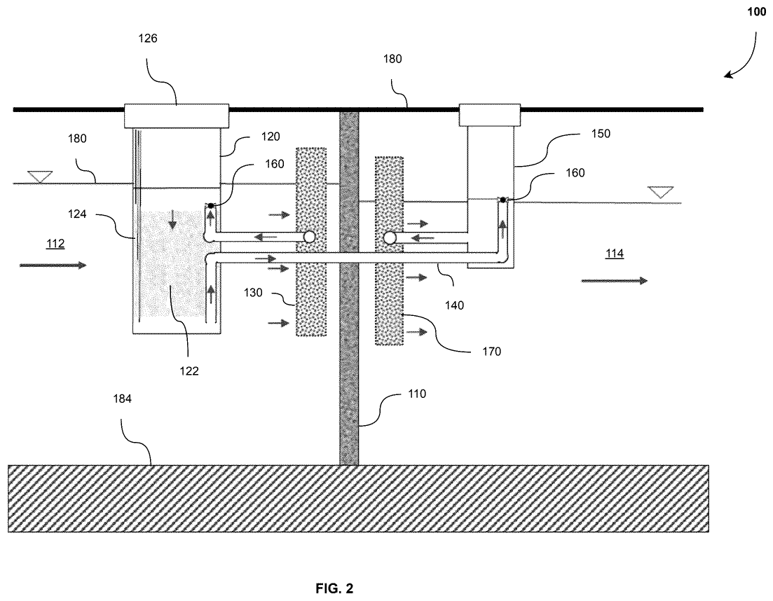

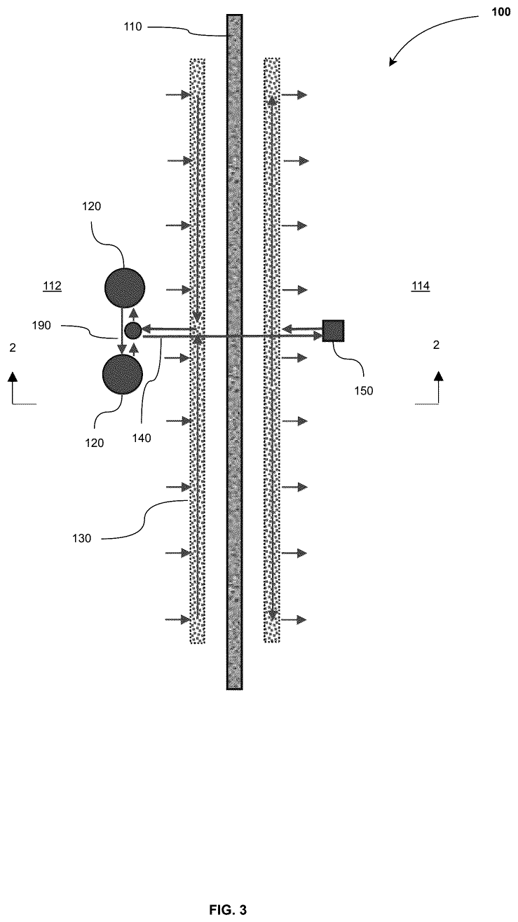

FIGS. 1 and 2 show a passive groundwater treatment barrier system 100 having various aspects included in various implementations. The passive groundwater treatment barrier system 100 shown in FIGS. 1 and 2 includes an in-situ hydraulic barrier wall 110, a water-tight treatment vessel 120, a groundwater infiltration and collection system 130, a hydraulic head control apparatus 150, a conveyance pipe 140, and a outlet 170. FIG. 3 shows another implementation of the passive groundwater treatment barrier system 100 including multiple water-tight treatment vessels 120 connected to an in-situ manifold 190 configured for lead-lag operation.

The passive groundwater treatment barrier system 100 includes an in-situ hydraulic barrier wall 110 constructed in the path of flow of a contaminated groundwater plume 182. As shown in FIG. 1, FIG. 2, and FIG. 3, the in-situ hydraulic barrier wall 110 may be positioned to intercept the contaminated groundwater plume 182.

The in-situ hydraulic barrier wall 110 may be constructed using various materials and methods to create an impermeable barrier that prevents or significantly reduces the passage of contaminated groundwater. In some cases, the in-situ hydraulic barrier wall 110 may be constructed as a slurry wall. The slurry wall may be composed of soil-bentonite mixtures, cement-bentonite mixtures, or combinations thereof. These mixtures may be designed to have very low hydraulic conductivity, effectively blocking the flow of groundwater through the barrier.

In some implementations, the in-situ hydraulic barrier wall 110 may be constructed using special sheet piles. These sheet piles may be designed and installed to minimize or prevent the passing of water through the barrier. The sheet piles may be made of materials such as steel, polyethylene, or composite materials that are resistant to corrosion and degradation in the subsurface environment.

The construction method for the in-situ hydraulic barrier wall 110 may vary depending on site conditions and design requirements. For slurry walls, a trench may be excavated along the desired barrier alignment and filled with the slurry mixture. The slurry may then be allowed to cure, forming a continuous, low-permeability barrier. For sheet pile walls, specialized equipment may be used to drive the interlocking sheets into the ground to the required depth.

In some cases, the in-situ hydraulic barrier wall 110 may extend from the ground surface 180 down to a competent aquitard layer 184, as depicted in FIG. 2. This configuration may help prevent contaminated groundwater from flowing beneath the barrier system. The barrier wall 110 may be keyed into the aquitard layer 184 to ensure hydraulic integrity and prevent vertical migration of contaminated groundwater beneath the barrier system.

For longer contaminated groundwater plumes 182 or complex site geometries, multiple in-situ hydraulic barrier walls 110 may be installed. In such cases, multiple treatment vessel 120, conveyance pipe 140, and hydraulic control apparatus 150 sets may be installed along one or more barrier walls 110. Each set may require separate upgradient infiltration systems 130 and downgradient exfiltration systems 170 to manage groundwater flow effectively.

In some implementations, the barrier wall 110 may be configured in a non-linear alignment based on at least one of groundwater contours, site topography, or surface features such as roads, buildings, and property boundaries. While the plan views in FIGS. 1 and 3 depict the barrier wall 110 as straight with parallel infiltration and exfiltration galleries, the barrier wall 110 may be configured in various non-linear configurations to accommodate site-specific conditions. Hydrogeologic modeling may be performed to optimize the design of the barrier wall 110 and the positioning of the infiltration and collection system 130 and the outlet 170.

The in-situ hydraulic barrier wall 110 may be designed to work in conjunction with other components of the passive groundwater treatment barrier system 100, such as the treatment vessels 120 and hydraulic control features, to effectively manage and treat the contaminated groundwater plume 182. Conveying the groundwater through the barrier wall 110 through a pipe 140, instead of a gap in the wall, reduces the potential for leakage of untreated groundwater through the wall.

The passive groundwater treatment barrier system 100 includes at least one water-tight treatment vessel 120 positioned upgradient of the barrier wall 110. As shown in FIG. 1, FIG. 2, and FIG. 3, the water-tight treatment vessel 120 may be located on the upstream side 112 of the in-situ hydraulic barrier wall 110, in the path of the contaminated groundwater flow. However, in some implementations, the at least one water-tight treatment vessel 120 may be positioned downgradient of the barrier wall 110. Positioning the treatment vessel(s) 120 upgradient of the barrier wall 110 may offer certain advantages. For instance, if a leak were to occur in the vessel, the leaked material would still be contained on the upgradient side 112 of the wall, potentially reducing the risk of untreated contaminants bypassing the system. Additionally, the groundwater level is typically higher on the upgradient side 112, which may allow the treatment vessel(s) 120 to be installed closer to the ground surface 180, potentially simplifying installation and maintenance procedures. While these considerations may not be major concerns in all cases, they represent some of the reasons why treatment vessels 120 are typically placed upgradient of the barrier wall 110.

The water-tight treatment vessel 120 may be constructed from various materials to ensure durability and resistance to corrosion in the subsurface environment. In some cases, the treatment vessel 120 may be constructed from large-diameter corrugated pipe. The pipe may consist of high-density polyethylene (HDPE), dual wall HDPE, or fiberglass reinforced polymer. These materials may provide excellent corrosion resistance and long-term stability in contact with soil and groundwater. In some implementations, corrugated galvanized steel culvert pipe may be used for the treatment vessel 120. When using steel pipe, cathodic protection may be recommended to extend the life of the vessel. In some implementations, the treatment vessel 120 is approximately 6 feet in diameter.

To ensure water-tightness, the treatment vessel 120 may be sealed at the bottom. This may be achieved by welding or otherwise attaching an endcap with sufficient strength to resist hydrostatic forces if the vessel needs to be emptied of media and water during maintenance operations.

In some implementations, the treatment vessel 120 may include tie-down features to prevent buoyancy-induced rising during media changeout. The potential for the treatment vessels 120 to rise out of the ground due to buoyancy during media changeout or service may be addressed by soil screws or other tie-down features.

The water-tight treatment vessel 120 may contain treatment media 122 designed to remove contaminants from the groundwater as it flows through the vessel. In some cases, the treatment media 122 may comprise granular activated carbon, ion exchange resin, surface-modified granular organo-clay media, or a combination thereof. The specific type of media used may depend on the contaminants present in the groundwater plume 182. In some implementations, the treatment media 122 comprises at least one of granular activated carbon, ion exchange resin, surface-modified granular organo-clay media, or other media configured to treat contaminants including at least one of PFAS, chlorinated volatile organic compounds, energetics, BTEX, or metals. Different media and multiple vessels can be designed to provide multi-stage treatment trains to concentrate and remove complex contaminant mixtures including long-chain PFAS, short-chain PFAS, chlorinated volatile organic compounds (CVOCs), energetics, BTEX, metals and other contaminants that can be adsorbed or destroyed by treatment media.

In some implementations, the treatment vessel 120 may be configured for downflow of groundwater through the media 122. This downflow configuration allows for more efficient treatment and easier maintenance of the system. The downflow design further enables selective removal and replacement of spent media while leaving the lower, still active layers in place. The downflow design enables inspection and maintenance of the upper portions of the media 122.

To monitor the performance of the treatment media 122 and determine when replacement is necessary, the treatment vessel 120 may be equipped with multiple sampling ports 124 positioned at different depths within the treatment media 122. These sampling ports 124 allow for monitoring of contaminant levels at various points in the treatment process. The sampling ports 124 may be installed before, at intermediate points, and after the media 122 to track the progression of contaminant adsorption through the media. This monitoring allows the contaminant front through the media 122 to be tracked to allow sufficient time for changeout prior to breakthrough.

In some implementations, the treatment vessel 120 includes intermediate horizontal distribution zones within the treatment media 122 to reduce channeling. The treatment media 122 may be placed in lifts with intermediate distribution zones to reduce channeling of water through the treatment media 122. The selection and configuration of the media 122 and treatment vessels 120 may be designed to minimize head loss and preferential channeling through the media 122.

In some cases, the treatment vessel 120 may be configured to allow for removal and replacement of a portion of the treatment media 122 while leaving a remaining portion in place. This may be particularly useful for replacing only the upper, more contaminated layers of media while leaving the lower, less contaminated layers intact. The removal and replacement of the upper portion of the treatment media 122 may be accomplished using vacuum pumps or slurry pumps. Vacuum pumps, such as those on vacuum trucks, may be used when the depth of the bottom of the treatment vessel 120 is less than 20 feet below ground surface (bgs). For deeper treatment vessels 120, submersible slurry pumps may be more suitable. After changeout, spent treatment media 122 may be sent off-site for at least one of reactivation or incineration, during which the PFAS and other contaminants are destroyed.

In some implementations, multiple treatment vessels 120 may be arranged in series, with each vessel containing a different type of treatment media 122. This configuration may allow for more comprehensive treatment of complex contaminant mixtures. For example, a first treatment vessel 120 may contain granular activated carbon for treating chlorinated volatile organic compounds and long-chain per-and polyfluoroalkyl substances (PFAS), while a second treatment vessel 120 may contain ion exchange resin for treating short-chain PFAS.

Alternatively, a single treatment vessel 120 may contain multiple layers of different treatment media 122. In some cases, the treatment media 122 may comprise a first layer of granular activated carbon and a second layer of ion exchange resin and/or surface-modified granular organo-clay media. This layered approach may allow for treatment of a wider range of contaminants within a single vessel.

For safety and maintenance purposes, the treatment vessel 120 may be provided with an access ladder, safety apparatus, and a locked cover 126. These features allow for safe entry and inspection of the vessel when necessary, while preventing unauthorized access.

The treatment vessels 120 and adsorption media 122 can achieve non-detect concentrations of PFAS and other contaminants in the treated groundwater. The treatment vessels 120 are typically designed with sufficient capacity to allow the periods between media changeouts to be measured in years.

The water-tight treatment vessel 120, in conjunction with other components of the passive groundwater treatment barrier system 100, provide an effective means of treating contaminated groundwater without the need for active pumping or energy-intensive processes.

FIG. 3 shows an implementation of the passive groundwater treatment barrier system 100 including multiple water-tight treatment vessels 120 connected to an in-situ manifold 190 configured for lead-lag operation. The in-situ manifold 190 may be located in a watertight manhole and enables the treatment vessels 120 to operate in lead-lag service. The manifold 190 allows isolation of individual treatment vessels 120 during media changeout. The in-situ manifold 190 may include valves configured to switch flow between lead and lag treatment vessels 120. The in-situ manifold 190 may also include shutoff valves configured to prevent untreated groundwater from passing through the barrier wall 110 during media changeout.

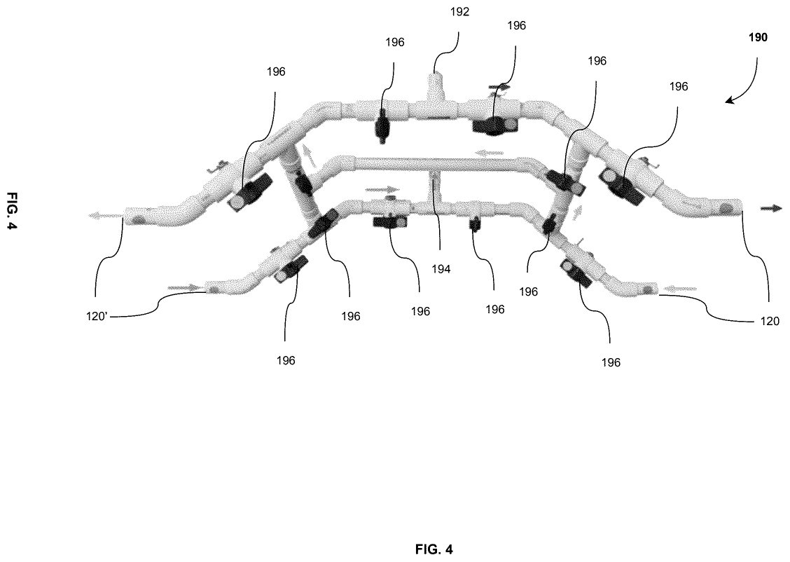

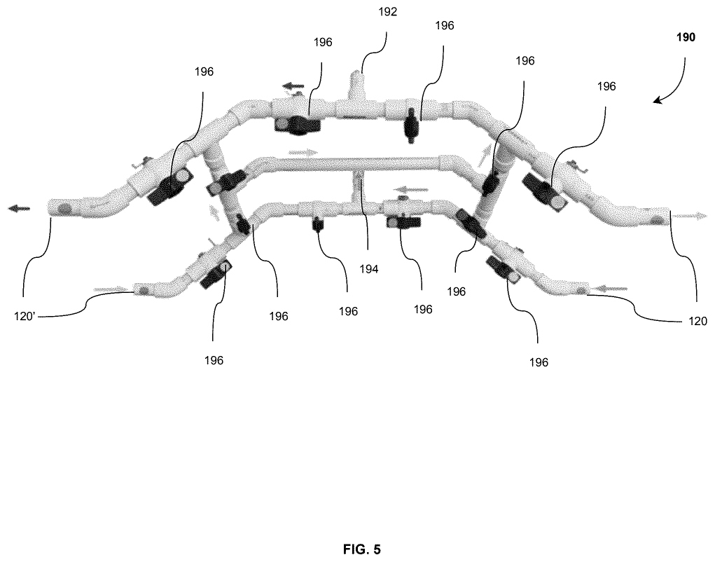

FIGS. 4 and 5 show isometric views of the in-situ manifold 190 in lead and lag configurations, respectively. As shown in FIGS. 4 and 5, the in-situ manifold 190 includes an influent connection 192 through which contaminated groundwater enters the manifold 190 from the groundwater infiltration and collection system 130. The in-situ manifold 190 also includes an effluent connection 194 through which treated groundwater exits the manifold 190 toward the hydraulic head control apparatus 150 and outlet 170. The in-situ manifold 190 includes multiple valves 196 positioned throughout the manifold piping to enable switching between a lead treatment vessel 120 and a lag treatment vessel 120′ and to allow isolation of individual treatment vessels 120, 120′ during media changeout operations. The in-situ manifold 190 further includes manifold sample ports distributed at various locations along the manifold piping to allow monitoring of influent, effluent, and intermediate streams for contaminant concentrations.

As shown in FIGS. 4 and 5, the in-situ manifold 190 may be constructed from PVC pipe, fittings, and valves 196. In some implementations, the in-situ manifold 190 may be constructed from 2-inch to 3-inch diameter PVC or polyethylene pipe. The in-situ manifold 190 may be located in a watertight manhole at a depth that is greater than the prevailing groundwater level outside the manhole. The watertight manhole may be built out of corrugated crosslinked polyethylene culvert pipe mounted vertically below grade with a polyethylene heat-welded bottom cap. The watertight manhole may also include a ladder and cover. A hoist mechanism, either portable or fixed, may be provided above the manhole for a safety harness for any worker who enters the manhole.

FIG. 4 shows the in-situ manifold 190 configured for lead vessel operation, where groundwater flows from the influent connection 192 through the lead treatment vessel 120 and then through the lag treatment vessel 120′ before exiting through the effluent connection 194. FIG. 5 shows the in-situ manifold 190 configured for lag vessel operation, where the valve positions have been adjusted to redirect flow such that the former lag vessel becomes the lead vessel. The valves 196 allow operators to isolate either treatment vessel 120, 120′ for maintenance while directing flow through the remaining vessel, and to switch the lead and lag designations after media changeout is complete.

In operation of the lead-lag configuration shown in FIG. 3 and FIGS. 4 and 5, a lead treatment vessel 120 may be isolated for maintenance and flow may be redirected to a lag treatment vessel 120′. The lag treatment vessel 120′ becomes a new lead treatment vessel 120 after maintenance is complete. This switchable lead/lag vessel configuration provides high reliability and allows for continuous treatment during media changeout operations. The manifold 190 enables a lead vessel 120 to be isolated for changeout while the flow is directed to the lag vessel 120.

In typical operation mode, both treatment vessels 120, 120′ may be filled with an adsorbent effective for PFAS, such as granular activated carbon (GAC), ion-exchange (IX) resin or surface-modified granular organo-clay media. Groundwater flows by gravity from the infiltration and collection system 130 on the upgradient side of the barrier wall 110, through the manifold 190 to the first, lead vessel 120, and then back through the manifold 190 to the lag vessel 120′ and then back through the manifold 190 to the outlet 170 on the downgradient side of the barrier wall 110. The multi-depth sampling ports 124 in the lead vessel 120 and its effluent may be periodically sampled and analyzed for PFAS and other site contaminants. When PFAS or other site contaminants break through the lead vessel 120, it may be temporarily taken offline by shutting off valves 196 in the manifold 190 and the flow is then directed through the lag vessel 120′. The lead vessel 120 treatment media 122 is then changed out with new or reactivated media. Valves 196 in the manifold 190 are then adjusted to convert the former lead vessel 120 into the lag vessel 120′ and vice versa.

Two sets of treatment vessels 120, 120′ may be installed in series to treat a variety of groundwater contaminants. Each set of treatment vessels 120, 120′ may have lead and lag vessels 120, 120′ and a control manifold 190. For example, if groundwater has both TCE and short-chain PFAS, the first set of treatment vessels 120, 120′ may be provided with GAC to remove the TCE and some of the PFAS, while the second set in series may be provided with IX resin to polish the remaining PFAS. This configuration may be advantageous because GAC is only partly effective on short-chain PFAS.

The passive groundwater treatment barrier system 100 includes a groundwater infiltration and collection system 130 upgradient of the barrier wall 110. As shown in FIG. 1, FIG. 2, and FIG. 3, the groundwater infiltration and collection system 130 may be positioned on the upstream side 112 of the in-situ hydraulic barrier wall 110, in the path of the contaminated groundwater flow.

The groundwater infiltration and collection system 130 may be designed to intercept and direct contaminated groundwater towards the treatment vessel 120. This system helps ensure that the contaminated groundwater is effectively captured and treated before reaching the barrier wall 110.

In some cases, the groundwater infiltration and collection system 130 may comprise French drains. French drains may be constructed by excavating trenches in the saturated zone and filling them with coarse-grained, higher permeability material. The trenches may be lined with geotextile and filled with sand and gravel. Perforated pipes may be installed within this fill material to collect and convey the groundwater.

Alternatively, the groundwater infiltration and collection system 130 may comprise one or more horizontal wells. Horizontal wells may be drilled through the saturated zone, parallel to the ground surface 180. These wells may be designed to intercept and collect contaminated groundwater over a larger area than vertical wells.

The choice between French drains and horizontal wells may depend on various factors, including site conditions, depth to groundwater, and installation feasibility. In some implementations, the groundwater infiltration and collection system 130 comprises French drains when depth to groundwater is less than 10 feet below ground surface, or horizontal wells when depth to groundwater is greater than 10 feet below ground surface. In some implementations, a combination of French drains and horizontal wells may be used to optimize groundwater collection.

The groundwater infiltration and collection system 130 may be designed to work in conjunction with the natural groundwater flow. By positioning the system upgradient of the barrier wall 110, contaminated groundwater may be directed through the treatment process without the need for active pumping.

In some cases, the groundwater infiltration and collection system 130 may extend along the entire length of the barrier wall 110. For longer barrier systems, multiple infiltration and collection zones may be implemented to ensure comprehensive capture of the contaminated groundwater plume 182.

The groundwater infiltration and collection system 130 may also help manage hydraulic head buildup behind the barrier wall 110. By providing a preferential flow path for groundwater, the system reduces the potential for contaminated water to flow around or under the barrier wall 110. The infiltration and collection system 130 and the outlet 170 allow the passive groundwater treatment barrier system 100 to perform in diverse hydrogeologic settings, including gravels, sands, silts and clays.

In some implementations, the groundwater infiltration and collection system 130 may be designed with multiple collection points or zones. This configuration may allow for more precise control of groundwater flow and may facilitate maintenance or repairs without compromising the entire system.

The materials used in the groundwater infiltration and collection system 130 may be selected for their durability and resistance to chemical degradation. This may be particularly important when dealing with aggressive contaminants or long-term remediation projects.

In some implementations, the groundwater infiltration and collection system 130 and the outlet 170 are positioned based on hydrogeologic modeling. Hydrogeologic modeling may evaluate the groundwater flux rate across the barrier wall 110, which may determine the flow rate through and sizing of the treatment vessels 120 and the design of the barrier wall 110 and infiltration/exfiltration galleries. The modeling may also help determine the shape and alignment of the barrier wall 110 to prevent groundwater flowing around the barrier.

By effectively capturing and directing contaminated groundwater, the groundwater infiltration and collection system 130 may play a crucial role in the overall performance of the passive groundwater treatment barrier system 100.

The passive groundwater treatment barrier system 100 includes a hydraulic head control apparatus 150 and a conveyance pipe 140. As shown in FIG. 1, FIG. 2, and FIG. 3, the hydraulic head control apparatus 150 may be connected to the treatment vessel 120 by a conveyance pipe 140 that passes through the barrier wall 110. The hydraulic head control apparatus 150 in FIG. 1, FIG. 2, and FIG. 3 is a hydraulic head control weir, but in some implementations, the hydraulic head control apparatus 150 can be a standpipe or other apparatus.

The conveyance pipe 140 may be designed to transport treated groundwater from the treatment vessel 120 through the barrier wall 110. In some cases, the conveyance pipe 140 may be constructed of durable, corrosion-resistant materials such as high-density polyethylene (HDPE) or stainless steel to ensure long-term reliability. The pipe may be sized appropriately to handle the expected flow rates of treated groundwater. The piping may be provided with access for cleanout.

The hydraulic head control apparatus 150 may play a crucial role in managing the water flow through the system. In some implementations, the apparatus may be adjustable, allowing for fine-tuning of the hydraulic head differential across the barrier wall 110. This adjustability may help optimize the treatment process and prevent undesired groundwater flow patterns. In some implementations, the hydraulic head control apparatus 150 comprises an adjustable weir configured to accommodate seasonal fluctuations in groundwater elevations.

The adjustable weir may be configured for at least one of manual adjustment or automated motorized control.

In some cases, the hydraulic head control apparatus 150 may be located downgradient of the barrier wall 110, as depicted in FIG. 1, FIG. 2, and FIG. 3. However, in other implementations, the apparatus may be positioned upgradient of the barrier wall 110, depending on site-specific requirements and hydraulic conditions.

The hydraulic head control apparatus 150 may be constructed using various materials and designs. In some cases, the apparatus may be a simple adjustable plate or gate that can be raised or lowered to control water levels. In other implementations, more complex apparatus designs may be employed to provide precise control over hydraulic head and flow rates.

By controlling the hydraulic head, the apparatus may help manage the flow rate through the treatment vessel 120 and minimize the potential for contaminated groundwater to flow under or around the barrier wall 110. This control may be particularly important in maintaining the effectiveness of the passive treatment system over time. The infiltration and collection system 130 and the outlet 170, along with the hydraulic control apparatus 150, serve to minimize the head drop across the barrier wall 110. This reduces the potential for contaminated groundwater to flow under or around the barrier wall 110. The design elevations of the treatment media 122, infiltration and exfiltration systems, the hydraulic control apparatus 150 and the associated piping may take into consideration the historical and seasonal variability in groundwater elevation contours, such that sufficient submerged depth is provided above the treatment media 122, and the hydraulic control apparatus 150 has sufficient vertical adjustability.

The combination of the conveyance pipe 140 and hydraulic head control apparatus 150 allows for the efficient transfer of treated groundwater through the barrier wall 110 while maintaining appropriate hydraulic conditions throughout the system. This arrangement contributes to the overall passive nature of the groundwater treatment barrier system 100, requiring minimal active intervention for ongoing operation.

The passive groundwater treatment barrier system 100 includes a distribution system 170 downgradient of the barrier wall 110 to disperse treated groundwater. As shown in FIG. 1, FIG. 2, and FIG. 3, the outlet 170 may be positioned on the downstream side 114 of the in-situ hydraulic barrier wall 110, in the path of the treated groundwater flow.

In some implementations, the groundwater infiltration and collection system 130 upgradient of the barrier wall 110 and the outlet 170 downgradient of the barrier wall 110 may be oriented parallel to the wall. However, these systems may also be installed at an angle to the wall if site conditions or design requirements necessitate such an arrangement. Parallel orientation of the outlet 170 on the downgradient side 114 may be preferred as it can help redistribute treated water more evenly across the area. This even redistribution may help maintain a more uniform hydraulic head differential across the barrier wall 110. If the treated water is not redistributed evenly, localized increases in hydraulic head differential may occur, potentially causing untreated groundwater on the upgradient side 112 to seek alternative flow paths, such as beneath or around the barrier wall 110. By optimizing the orientation and design of these systems, the overall effectiveness of the passive groundwater treatment barrier system 100 may be enhanced.

The outlet 170 may be designed to effectively disperse the treated groundwater back into the subsurface environment or to direct it to a designated discharge point. This system may help ensure that the treated groundwater is properly reintroduced into the environment without causing localized flooding or other hydraulic issues. The outlet 170 directs the groundwater flow through the in-situ treatment vessels 120 and then redistributes the treated groundwater to minimize disruption of the groundwater contours.

In some cases, the outlet 170 may comprise French drains. French drains may be constructed by excavating trenches in the saturated zone and filling them with coarse-grained, higher permeability material. Perforated pipes may be installed within this fill material to distribute the treated groundwater.

Alternatively, the outlet 170 may comprise one or more horizontal wells. Horizontal wells may be drilled through the saturated zone, parallel to the ground surface 180. These wells may be designed to distribute treated groundwater over a larger area than vertical wells.

The choice between French drains and horizontal wells for the outlet 170 may depend on various factors, including site conditions, depth to groundwater, and installation feasibility. In some implementations, a combination of French drains and horizontal wells may be used to optimize treated groundwater distribution.

The outlet 170 may be designed to work in conjunction with the natural groundwater flow. By positioning the system downgradient of the barrier wall 110, treated groundwater may be dispersed without the need for active pumping.

In some cases, the outlet 170 may extend along the entire length of the barrier wall 110. For longer barrier systems, multiple distribution zones may be implemented to ensure comprehensive dispersion of the treated groundwater.

The outlet 170 may also help manage hydraulic head buildup downgradient of the barrier wall 110. By providing a preferential flow path for treated groundwater, the system may reduce the potential for localized mounding or other undesirable hydraulic effects.

In some implementations, the outlet 170 may be designed with multiple discharge points or zones. This configuration may allow for more precise control of treated groundwater dispersion and may facilitate maintenance or repairs without compromising the entire system.

The materials used in the outlet 170 may be selected for their durability and resistance to chemical degradation. This may be particularly important when dealing with long-term remediation projects or sites with challenging geochemical conditions.

In some cases, the outlet 170 may be designed to discharge treated groundwater to surface water bodies or municipal sewer systems, depending on site topography and regulatory requirements. For some sites, the treated water can be conveyed to surface water or sewer instead of an exfiltration gallery. However, discharging the treated water to surface water or sewer will tend to lower the groundwater elevations downgradient of the barrier wall 110 and increase the head drop across the wall. In such instances, the integrity of the aquitard layer 184 needs to be considered. This flexibility in discharge options may allow the passive groundwater treatment barrier system 100 to be adapted to a wide range of site conditions and constraints.

By effectively dispersing treated groundwater, the outlet 170 plays a crucial role in the overall performance of the passive groundwater treatment barrier system 100, helping to maintain proper hydraulic balance and ensuring the long-term effectiveness of the remediation effort.

In some implementations, the system 100 is configured for sites where depth to groundwater is less than 25 feet below ground surface and depth to a competent aquitard is less than 100 feet below ground surface. Optimal hydrogeologic conditions for the passive groundwater treatment barrier system 100 may consist of sites where the depth to groundwater is less than 25 feet below ground surface (bgs) and the depth to a competent aquitard layer 184 is less than 50 feet bgs. However, the passive groundwater treatment barrier system 100 may be a viable remediation alternative for sites with competent aquitards as deep as 100 feet. The passive groundwater treatment barrier system 100 works well in a variety of soil conditions from clays and silts to sands and gravels and interbedded deposits.

The passive groundwater treatment barrier system 100 integrates multiple components to effectively treat contaminated groundwater without the need for active pumping or energy-intensive processes. As shown in FIG. 1, FIG. 2, and FIG. 3, the system components work together to intercept, treat, and redistribute contaminated groundwater using natural hydraulic gradients.

In operation, contaminated groundwater flows towards the in-situ hydraulic barrier wall 110. The groundwater infiltration and collection system 130, positioned upgradient of the barrier wall 110, intercepts this flow and directs it towards the water-tight treatment vessel 120.

In some cases, the contaminated groundwater may pass in a downflow direction through the water-tight treatment vessel 120 containing treatment media 122. This downflow configuration may allow for more efficient contaminant removal and easier maintenance of the system. The treatment vessel 120 may be positioned upgradient of the barrier wall 110 to take advantage of the natural hydraulic gradient. However, in some implementations, the at least one water-tight treatment vessel 120 may be positioned downgradient of the barrier wall 110. While the treatment vessel(s) 120 are typically located upgradient of the barrier wall 110 to take advantage of natural hydraulic gradients, positioning them downgradient may be advantageous in certain site-specific scenarios or hydraulic conditions. This flexibility in treatment vessel placement allows the system to be adapted to a wider range of site configurations and groundwater flow patterns.

The treatment media 122 within the vessel may be selected based on the specific contaminants present in the groundwater. In some implementations, multiple treatment vessels 120 may be arranged in series to address complex contaminant mixtures. For example, a first treatment vessel 120 may contain granular activated carbon for treating chlorinated volatile organic compounds and long-chain per-and polyfluoroalkyl substances (PFAS), while a second treatment vessel 120 may contain ion exchange resin for treating short-chain PFAS. This arrangement may allow for comprehensive treatment of various contaminant types.

After passing through the treatment vessel(s) 120, the treated groundwater may flow through a conveyance pipe 140 that passes through the barrier wall 110. The hydraulic head control apparatus 150, connected to this pipe, may help manage the water flow through the system and maintain appropriate hydraulic conditions.

The outlet 170, positioned downgradient of the barrier wall 110, may then disperse the treated groundwater back into the subsurface environment or direct it to a designated discharge point. This system may help ensure proper reintroduction of treated water without causing localized hydraulic issues.

In some cases, the water-tight treatment vessel(s) 120 may be equipped with shutoff valves 160 configured to isolate the vessel from surrounding groundwater. These valves may be particularly useful during maintenance operations. By closing the shutoff valves 160, the treatment vessel 120 may be isolated from the surrounding groundwater, allowing for safe and efficient maintenance activities such as media replacement or vessel inspection. During media replacement, valves 160 allow for complete temporary isolation of the treatment vessels 120 such that untreated groundwater is not allowed to pass through the barrier wall 110.

The passive nature of this groundwater treatment barrier system 100 may offer several advantages over conventional pump-and-treat systems. By leveraging natural hydraulic gradients, the system may operate without the need for pumps or other energy-intensive equipment, potentially reducing long-term operational costs and energy consumption. The use of in-situ components may also minimize surface disturbance and reduce the need for aboveground treatment facilities. The passive groundwater treatment barrier system 100 offers superior reliability and lower life-cycle cost advantages over pump-and-treat systems, because a pump-and-treat system is costly to install, very costly to operate over time, and its reliability at preventing the migration of contaminated groundwater is dependent on the continuous operation of the pumps. Power failures, pump failures and unanticipated localized groundwater flux can undermine the reliability of pump-and-treat systems.

Additionally, the system's modular design, with the potential for multiple treatment vessels 120 arranged in series, may allow for flexibility in addressing various contaminant types and concentrations. This adaptability may be particularly beneficial for sites with complex or evolving contaminant profiles.

The integration of hydraulic control features, such as the infiltration and collection system 130, hydraulic head control apparatus 150, and outlet 170, may help ensure effective capture and treatment of the contaminated groundwater plume 182 while maintaining appropriate hydraulic conditions throughout the system. This may contribute to the overall reliability and long-term effectiveness of the groundwater remediation effort.

The passive groundwater treatment barrier system 100 may offer advantages over other funnel-and-gate designs, trenched permeable reactive barriers (PRBs) and injection-based PRBs. The treatment vessels 120 and the conveyance pipe 140 conveying treated water through the barrier wall 110 differ from gates in other funnel-and-gate installations where the gate is a gap in the barrier wall. In such designs, the treatment media is either placed in the ground in the gap or in cassettes that are lowered into a subsurface structure designed to hold the cassettes. Replacing the media in gates where the media is placed directly in the ground requires costly excavation and shoring. Furthermore, to prevent untreated water from escaping through the gate during media changeout, costly dewatering and treatment of the groundwater is necessary.

The passive groundwater treatment barrier system 100 is more reliable than other funnel-and-gate designs because the infiltration and collection system 130 upgradient of the barrier wall 110 and the outlet 170 downgradient of the barrier wall 110 serve to minimize the head drop across the barrier wall 110. The minimal head drop across the barrier wall 110 reduces the potential for contaminated groundwater from flowing under or around the barrier wall 110.

The passive groundwater treatment barrier system 100 may also offer advantages over trenched PRBs. Trench PRBs are vulnerable to localized premature breakthroughs of untreated groundwater because the groundwater flow rates and contaminant mass flux rates can vary locally by orders of magnitude in comparison to an average due to subsurface variability in soil permeabilities. In contrast, the passive groundwater treatment barrier system 100 provides a reliable physical barrier to the migration of contaminated groundwater, and all of the upgradient contaminated groundwater is conveyed through the treatment vessels 120.

The passive groundwater treatment barrier system 100 may also provide advantages over injection-based PRBs that are created by injecting adsorptive material into the formation. The primary reliability weakness of such PRBs lies in their inability to achieve complete horizontal and vertical integrity throughout their alignment in the saturated zone. This is often due to the heterogeneity of the soils in the saturated zone and the gaps between injection points. The passive groundwater treatment barrier system 100 avoids these limitations because the spent adsorption media 122 is easily removed and replaced, and the spent media 122 is removed from the site and treated or regenerated off-site where the contaminants are destroyed.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A passive groundwater treatment barrier system, comprising:
an in-situ hydraulic barrier wall constructed in a path of flow of a contaminated groundwater plume;
at least one water-tight treatment vessel containing a treatment media and configured for downflow of groundwater through the media;
a groundwater infiltration and collection system upgradient of the barrier wall to convey contaminated groundwater to the treatment vessel;
a hydraulic head control apparatus;
a conveyance pipe passing through the barrier wall and connecting the treatment vessel to
the hydraulic head control apparatus; and
an outlet downgradient of the barrier wall to release treated groundwater.

2. The system of claim 1, wherein the treatment media comprises at least one of granular activated carbon, ion exchange resin, surface-modified granular organo-clay media, or a combination thereof.

3. The system of claim 1, wherein the treatment vessel comprises multiple sampling ports positioned at different depths of the treatment media.

4. The system of claim 1, wherein the groundwater infiltration and collection system comprises at least one of French drains or horizontal wells.

5. The system of claim 1, wherein the outlet comprises a distribution system comprising at least one of French drains or horizontal wells.

6. The system of claim 1, further comprising shutoff valves configured to isolate the treatment vessel from surrounding groundwater.

7. The system of claim 1, wherein the treatment vessel is configured to allow for removal and replacement of a portion of the treatment media while leaving a remaining portion of the treatment media in place.

8. The system of claim 7, wherein the treatment vessel is configured to allow for removal and replacement of an upper portion of the treatment media using at least one of vacuum pumps or slurry pumps.

9. The system of claim 1, wherein the at least one water-tight treatment vessel is positioned upgradient of the barrier wall.

10. The system of claim 1, further comprising multiple treatment vessels arranged in series, wherein one or more treatment vessels contain a different type of treatment media than one or more other treatment vessels.

11. The system of claim 10, wherein a first treatment vessel contains granular activated carbon, and a second treatment vessel contains ion exchange resin and/or surface-modified granular organo-clay media.

12. The system of claim 1, wherein the hydraulic head control apparatus comprises a weir.

13. The system of claim 1, further comprising multiple water-tight treatment vessels connected to an in-situ manifold configured for lead-lag operation, wherein the manifold allows isolation of individual treatment vessels during media changeout.

14. The system of claim 1, further comprising an in-situ manifold connecting multiple treatment vessels, the in-situ manifold located in a watertight manhole.

15. The system of claim 1, further comprising an in-situ manifold connecting multiple treatment vessels, the in-situ manifold including valves configured to switch flow between lead and lag treatment vessels.

16. The system of claim 1, further comprising an in-situ manifold connecting multiple treatment vessels, the in-situ manifold including shutoff valves configured to prevent untreated groundwater from passing through the barrier wall during media changeout.

17. The system of claim 1, wherein the hydraulic head control apparatus comprises an adjustable weir configured to accommodate seasonal fluctuations in groundwater elevations.

18. The system of claim 17, wherein the adjustable weir is configured for at least one of manual adjustment or automated motorized control.

19. The system of claim 1, wherein the treatment vessel includes intermediate horizontal distribution zones within the treatment media to reduce channeling.

20. The system of claim 1, wherein the treatment vessel includes tie-down features to prevent buoyancy-induced rising during media changeout.

21. The system of claim 1, wherein the treatment vessel is from 3 feet to 8 feet in diameter.

22. The system of claim 1, wherein the treatment media comprises at least one of granular activated carbon, ion exchange resin, surface-modified granular organo-clay media or other media configured to treat contaminants including at least one of PFAS, chlorinated volatile organic compounds, energetics, BTEX, or metals.

23. The system of claim 1, wherein the barrier wall is configured in a non-linear alignment based on at least one of groundwater contours, site topography, or surface features.

24. The system of claim 1, wherein the groundwater infiltration and collection system and the outlet are positioned based on hydrogeologic modeling.

25. The system of claim 1, wherein the system is configured for sites where depth to groundwater is less than 25 feet below ground surface and depth to a competent aquitard is less than 100 feet below ground surface.

26. The system of claim 1, wherein the groundwater infiltration and collection system comprises French drains when depth to groundwater is less than 10 feet below ground surface, or horizontal wells when depth to groundwater is greater than 10 feet below ground surface.

27. The system of claim 1, further comprising a watertight manhole comprising corrugated crosslinked polyethylene culvert pipe mounted vertically below grade with a heat-welded bottom cap.

28. The system of claim 1, further comprising a hoist mechanism positioned above a watertight manhole containing an in-situ manifold.

29. The system of claim 1, further comprising multiple treatment vessels configured for series flow during normal operation, wherein groundwater flows through a lead treatment vessel and then through a lag treatment vessel before being released through the outlet.

30. The system of claim 1, further comprising multiple sets of treatment vessels arranged in series, each set comprising a lead vessel and a lag vessel connected to a control manifold.

31. The system of claim 30, wherein a first set of treatment vessels contains granular activated carbon and a second set of treatment vessels contains ion exchange resin and/or surface-modified granular organo-clay media.

32-51. (canceled)
